(19) United States
(12) Patent Application Publication
(10) Pub. No.: US 2025/0069062 A1
(43) Pub. Date: Feb. 27, 2025

(54) DECENTRALIZED USE OF ZERO KNOWLEDGE PROOF WITH ENHANCED IDENTITY CREDENTIALS TO LOWER EXTERNAL COUNTER PARTY RISKS, FOR EXAMPLE TO COMBAT MONEY LAUNDERING

(71) Applicant: MatterFi, Sheridan, WY (US)

(72) Inventor: Michal Pospieszalski, West Hollywood, WY (US)

(73) Assignee: MatterFi, Sheridan, WY (US)

(21) Appl. No.: 18/815,394

(22) Filed: Aug. 26, 2024

Related U.S. Application Data
(60) Provisional application No. 63/578,658, filed on Aug. 24, 2023.

(51) Int. Cl. G06Q 20/36

(52) U.S. Cl. CPC G06Q 20/367

(57) ABSTRACT

A cryptocurrency system with a communication channel, a wallet, where the wallet has a paycode and associated private key and the paycode is associated to enhanced identity. The wallet can send a zero knowledge proof on the communication channel to prove ownership of the private key and thus proof of the enhanced identity information. The wallet may include a blockchain address and associated private key. The wallet may send a zero knowledge proof on the communication channel to prove ownership of the blockchain address and thus provide proof of funds. The cryptocurrency system may include a communication channel, a wallet with a private key, where the wallet can send a zero knowledge proof on the communication channel to prove control of the private key.

### CROSS-REFERENCE TO RELATED APPLICATIONS

This application claims the benefit of U.S. Provisional Patent Application No. 63/578,658, filed on Aug. 24, 2023, entitled “Decentralized Use of Zero Knowledge Proof with Enhanced Identity Credentials to Lower External Counter Party Risks, for Example to Combat Money Laundering,” which is incorporated by reference in its entirety for all purposes. Incorporation by reference of any document is limited such that no subject matter is incorporated that is contrary to the explicit disclosure of this document.

### BACKGROUND

### Field

This disclosure relates generally to blockchain-based systems and decentralized finance (DeFi), particularly in relation to identity verification and transaction security. More specifically, the invention provides enhanced identity wallets that utilize cryptographic methods, such as Zero-Knowledge Proof (ZKP), to help ensure transparency and security in cryptocurrency transactions.

### Background

One of the persistent problems in blockchain and cryptocurrency systems is the inherent anonymity of wallet addresses. While transactions are transparent and traceable on the blockchain, the identity of the person or entity controlling a specific address remains hidden unless voluntarily disclosed. This anonymity creates opportunities for misuse, as bad actors can exploit the system to conduct illicit activities such as money laundering, fraud, or financing criminal enterprises. Despite knowing the source address of a transaction, there is no mechanism to reliably verify who is behind that address. Thus, even if funds are transferred from a legitimate wallet, the lack of identity validation introduces vulnerabilities that allow bad actors to obfuscate their true identities.

These risks are particularly problematic in custodial systems like banks or exchanges, which receive funds from external addresses without certainty regarding the originator's identity. Without knowing who controls the sending address, these systems become susceptible to attacks by individuals using stolen or tainted funds to mix with legitimate deposits. For example, a user could deposit funds into a legitimate account but then leverage the same receiving address to funnel illicit gains through another wallet, creating an avenue for laundering money.

Existing identity verification systems, including KYC (Know Your Customer) protocols, attempt to mitigate these risks but often fail to integrate directly with decentralized blockchain transactions. This disconnection between identity and blockchain activity leaves gaps that bad actors can exploit. Thus, there is a need for a system that securely links identity to blockchain transactions without sacrificing the privacy and security of legitimate users.

### BRIEF SUMMARY

A cryptocurrency system with a communication channel, a wallet, where the wallet has a paycode and associated private key and the paycode is associated to enhanced identity. The wallet can send a zero knowledge proof on the communication channel to prove ownership of the private key and thus proof of the enhanced identity information.

The wallet may include a blockchain address and associated private key. The wallet may send a zero knowledge proof on the communication channel to prove ownership of the source and thus provide proof of funds.

The cryptocurrency system may include a communication channel, a wallet with a private key, where the wallet can send a zero knowledge proof via the communication channel to prove control of the private key.

### BRIEF DESCRIPTION OF THE DRAWINGS

FIG. 1 illustrates a high-level diagram of the process that may be used to establish a transaction between two parties that includes a Zero Knowledge Proof.

### DETAILED DESCRIPTION

Using BIP-47/OBPP-5 payment codes combined with enhanced identity credentials and the use of a ZK proof allows the parties in a crypto transaction to know that the source funds address is spendable by the private key that generated a senders paycode (and associated name and identity) and a counterparty's receive address. In addition, the use of the paycode with enhanced identity enables users to send/receive by using names, instead of long and complex cryptographic addresses.

In the sending wallet, the master private key (and corresponding child derived keys) are used to compute a receiving address for paycode transactions. The sender's child private keys are cryptographically tied to the sender's paycode, and the paycode—by the enhanced identity—is associated with the name and identity of the sender. Further, the master private key is used to generate the paycode.

It would be useful to prove that the source of funds that arrive at the receive address are controlled by a private key that was derived from the master private key, the same master private key used to generate the paycode associated to the name and identity (the enhanced identity).

The useful proof noted above solves the following vulnerability:
The system may be vulnerable to having a computed receive address used in a nefarious manner. Knowing the computed receive address may allow a 3^{rd} party or bad-actor to send funds to the computed receive address from sources that are not controlled by a sender's wallet. Since the calculated address does not require the funds to be sent from the sender's private address (but rather will accept funds from any address), crypto assets from any address (even a bad actor's address) could be the source of the funds, which means that an innocent person thinking they are receiving money from the identified person could unknowingly be receiving funds from a different, potentially malicious, wallet. This vulnerability creates a potential avenue for money laundering or other deceptive practices.
For a bad actor to identify a receive address, they do not need access to the private keys for the wallet. Merely eavesdropping on a transaction can provide insight into funds being sent to a receive address. This knowledge can be obtained in various ways, such as:
   Analyzing the Blockchain: Given the transparent nature of most blockchain transactions, an attacker can monitor and analyze transaction data to identify receive addresses.
   Intercepting Communication: If two parties are communicating about a transaction through insecure channels, a bad actor might intercept this communication and learn about the receive address.
   Colluding with Malicious Nodes: In decentralized networks, if an attacker has control over a significant number of nodes, they can potentially gain insights into specific transaction details that are otherwise obfuscated to individual nodes.
   Phishing Attacks: By pretending to be a legitimate entity, attackers can deceive users into revealing details about their transactions, including the receive address.
For example, say there is a user that has a verified KYC (Know Your Customer) identity called “innocent_grandma_A” with a wallet A with private key A controlling address A on the blockchain and grandma A uses address A to transfer assets on the blockchain into a crypto address under control of custody system B (for example, bank B) using a receive address B-receive-address-from-A. All the funds moving from address A to B-receive-address-from-A are legitimate and normally untainted and therefore after a bit of time the custody system B may assume that all money deposited into B-receive-address-from-A are funds that are coming from sources controlled by private key A. However, a bad-actor could determine the B-receive-address-from-A, for example by examining the transactions being performed by wallet A. Then with that B-receive-address-from-A a bad-actor could take another wallet Z that the bad-actor controls, one that is filled with stolen funds, and then send assets from that Z wallet to the B-receive-address-for-A address. They may also give the B-receive-address-from-A receive address to criminal third parties for them to send funds to B-receive-address-for A address. In this scenario B would not be able to tell the difference in the source of funds and thus money laundering may occur if the funds are then exchanged in the custody system upon deposit. If the bad actor and “innocent_grandmaA” are colluding or are the same person then now wallet A could withdraw the exchanged funds thus potentially successfully performing money laundering.

To thwart this attack, a non-interactive Zero Knowledge proof can prove that the funds sent are in fact controlled by the private key of sender A and that same private key is cryptographically proven to be tied to the sender A paycode and associated to the identity through the enhanced identity.

In Bitcoin and many other cryptocurrencies, a cryptographic technique called Elliptic Curve Digital Signature Algorithm (ECDSA) is used to generate public-private key pairs and verify signatures. When funds are at a certain address, there is a private key corresponding to that public address. A recipient of funds after receiving the funds at a receive address computed by the OBPP-5/BIP-47 protocol can inspect the on-chain transactions and see the address or addresses that the funds originated from. The zero-knowledge-proof proof when sent via a side channel (also known as a multimodal pathway or signaling pathway) would further prove not only that the receive address was computed by a specific paycode (which is linked through enhanced identity to the sender, i.e., enhanced credentials) but that also the funds sent to the receiving address came from a private key known to the sender that can spend those funds and that same private key is a child private key derived from the master key used to compute the senders paycode.

In the context of this specification, the term “blockchain” is used as an example of a distributed ledger system. However, it should be understood that the methods and systems described herein are not limited to blockchain specifically but may apply to any form of distributed ledger technology (DLT). Distributed ledger technology encompasses a wide variety of implementations where data is maintained across multiple nodes, typically with decentralized control, ensuring security, transparency, and resistance to tampering. Blockchain is one example of such a system, but the methods described may be implemented in other distributed ledger systems, such as directed acyclic graphs (DAGs), hashgraph, or other consensus-based, decentralized data structures that maintain a verifiable record of transactions.

zkSNARK: Zero-Knowledge Succinct Non-Interactive Argument of Knowledge and refers to a proof construction where one can prove possession of certain information, e.g., a secret key, without revealing that information, and without any interaction between the prover and verifier. (in this case the prover is the sender and the verifier is the receiver)

Here is a step-by-step implementation of the zkSNARK version of the Schnorr protocol to prove control of a private key corresponding to a known public key P (source address SA) and that the same private key is derived from a master private key that created the sender paycode (PC).

Zero Knowledge Proof 1: Proof of control over both sending address and sender Payment code thus providing proof the funds come from the person/entity specified in the enhanced identity.

### 1. Commitment Phase:

The sender selects two random numbers: r₁ and r₂.
They then calculate: R₁=r₁*G and R₂=r₂*G (Where In cryptographic contexts, G represents a predetermined point on an elliptic curve. This point is universally known by participants in a specific blockchain system. In the case of Bitcoin, this predetermined point is referred to as ‘secp256k1’).

### 2. Challenge Phase:

1. The sender challenge is computed as: e=H(R₁∥R₂∥P∥PC). Where H is a hash function, ∥ denotes concatenation,
   R₁ is a first commitment point related to proving control over a private key linked with public key P,
   P is the public key (source address SA),
   R₂ is a second commitment point associated with proving control over the private component of payment code PC, and
   PC is the sender's payment code. This binds the challenge to the specific public key and the payment code.

### 3. Response Phase:

The sender calculates: s₁=r₁+e*k
And also: s₂=r₂+e*k_{PC}
   (where k is the private key associated with the source address SA).
   (where k_{PC} is the private key associated with the paycode PC).

### 4. Proof:

The sender provides proof (R₁, R₂, s₁, s₂) to the receiver.

### 5. Verification:

1. The receiver checks: s₁*G=R₁+e*P
2. And also: s₂*G=R₂+e*G_{PC}

If both equations hold, the receiver can be confident about the user's control over the private components of both P and PC where again P is a known public key corresponding to the source address SA, and PC is the sender paycode.

If the verification equation holds, then one can be sure that the sender controls the private key for the public key P and P's private key has control over the private key that is associated with the paycode PC, without learning anything about the private keys themselves. That is the “zero-knowledge” property. And since the verifier (sender) generates the challenge themselves rather than receiving it from the receiver, the proof is also non-interactive, as required by a zkSNARK.

Zero Knowledge Proof 2: Proof of control of sender Payment code (this proof maybe used to prove any information contained in the enhanced Identity).
1. Commitment The sender generates a random number r and calculate R=r*G. (Where In cryptographic contexts, G represents a predetermined point on an elliptic curve. This point is universally known by participants in a specific blockchain system. In the case of Bitcoin, this predetermined point is referred to as ‘secp256k1’.)
2. Challenge: The sender computes e=H(R∥PC), where H is a hash function, ∥ denotes concatenation, R is the commitment and PC is the sender's payment code. This binds the challenge to the payment code.
3. Response: The sender calculates s=r+e*k_{PC}, where k_{PC} is the private key associated with the payment code PC.
4. Proof: The sender send the proof, which consists of (R, s) to the verifier.
5. Verification: The verifier (receiver), who knows the source address P, the payment code PC and receives (R, s), verifies the proof by computing e=H(R∥PC) and checking that s*G=R+e*PC.

Note this Proof may be used to show control over the sender paycode, and proof over the sending address will come when the transaction come across on the blockchain.

Zero Knowledge Proof 3: Proof of control over an address (i.e. a sending address), and this proof may be used for proof of funds.
1. Commitment The sender generates a random number r and calculate R=r*G. (Where In cryptographic contexts, G represents a predetermined point on an elliptic curve. This point is universally known by participants in a specific blockchain system. In the case of Bitcoin, this predetermined point is referred to as ‘secp256k1’.)
2. Challenge: The sender computes e=H(R∥P), where H is a hash function, ∥ denotes concatenation, R is the commitment, P is the public key (source address SA). This binds the challenge to the source address.
3. Response: The sender calculates s=r+e*k, where k is the private key associated with the source address P.
4. Proof: The sender sends the proof, which consists of (R, s) to the verifier.
5. Verification: The verifier (receiver), who knows the source address P and receives (R, s), verifies the proof by computing e=H(R∥P) and checking that s*G=R+e*P.

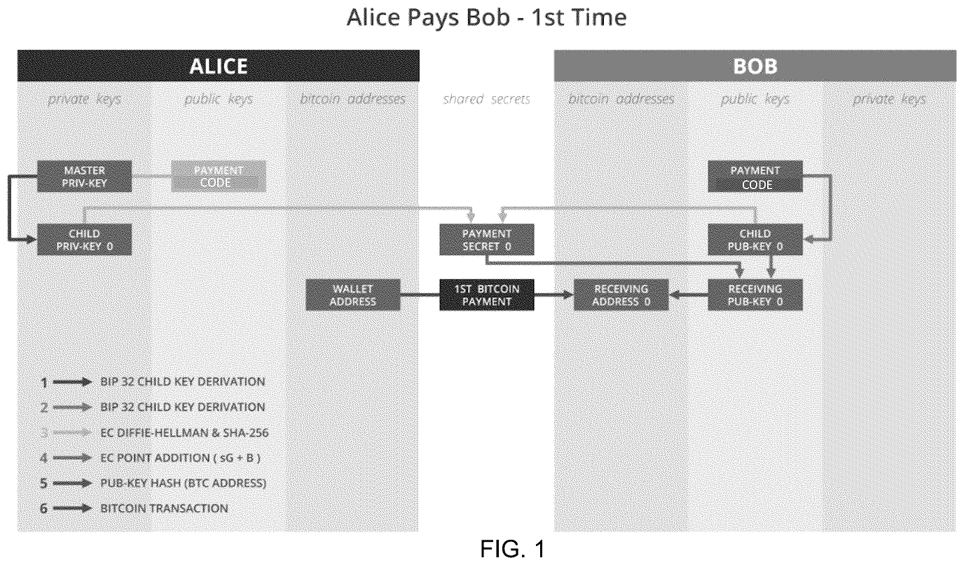

To tie this in to the diagram in FIG. 1, the zkSNARK verifies that Alice's source “wallet address” (not depicted in diagram) is in fact controlled by a private key known to Alice. A side-channel communication may provide the zkSNARK proof—for example proof (R₁, R₂, s₁, s₂)—and this proof may be used by the receiver to verify that sending wallet has control over the paycode, PC, and the address P.

Other mechanisms of proof may show that the sender Address P and the Paycode PC are derivatives of the “master private-key.” The proof may show that the same private key is a derivative of the “master private-key”

An implementation may consist of two steps:
1. When a TX is sent using the BIP-47/OBPP-5 scheme, simultaneously the above zkSNARK protocol would be used by the sender, Alice, to generate a proof, for example proof (R₁, R₂, s₁, s₂) that would be sent, for example via a side channel such as chat to the recipient, Bob.
2. Upon receiving the funds, the recipient Bob would know the sending paycode (PC) from the OBPP-5 signaling system and the source address P from examining the TX performed in step 1 on-chain. With P and PC known, the recipient may then perform verification step of the zkSNARK protocol (for example check that s₁*G=R₁+e*P and s₂*G=R₂+e*G_{PC}) to confirm that the sender has control over to the private keys associated with PC and P. And further from doing the OBPP-5 calculations that the receive address was uniquely computed by the sending paycode (PC).

If the funds came from multiple source addresses, then the proof/verification would be completed for each of the source addresses.

In a variant of the above two step process the sending wallet constructs and transmits a set of zkproofs verifying that all the sending-addresses the sending wallet would use to send funds, so that the receiver would know that those sending-addresses were controlled by the private keys of the sending wallet. Then any subsequent transactions, sent from all the different sending-addresses, could be verified even if a specific proof for a particular subset of source addresses was not sent along with each transaction.

Additionally, the paycode may have enhanced credentials as described in the patent titled “PRIVACY-PRESERVING CRYPTOCURRENCY TRANSACTIONS WITH ENHANCED CREDENTIALS AND USER-FRIENDLY PAYCODE INFRASTRUCTURE.”

This application incorporates by reference U.S. Provisional Patent Application Ser. No. 63/507,085, filed on Jun. 8, 2023, titled “PRIVACY-PRESERVING CRYPTOCURRENCY TRANSACTIONS WITH ENHANCED CREDENTIALS AND USER-FRIENDLY PAYCODE INFRASTRUCTURE” and PCT Application No. PCT/US24/33224, filed on Jun. 10, 2024, titled “PRIVACY-PRESERVING CRYPTOCURRENCY TRANSACTIONS WITH ENHANCED CREDENTIALS AND USER-FRIENDLY PAYCODE INFRASTRUCTURE.” The contents of both applications are hereby incorporated by reference in this entirety into the specification of the present application. Incorporation by reference of any document is limited such that no subject matter is incorporated that is contrary to the explicit disclosure of this document.

The above protocol would prove to the recipient that the received funds only came from sources controlled by a particular private key and to an address that was only computed by the same private key. Thus, any attempted money launderer would have to first deposit all suspect funds into the same wallet that would subsequently be used to send the funds to a third party. Therefore, any attempted money laundering could be easily identified.

The point is to prove the addresses are controlled by the same root key. There is no need to tie the proof to the transaction itself, just to its source address or addresses. When a transaction comes in from that address the proof can be used to verify the association to the identity that is the source of the funds.

The ZKP (Zero Knowledge Proof) can be combined with any Crypto transaction, it can be sent on a communication channel. The ZKP can be used to provide proof of funds by conveying the identity is tied to the paycode is also tied to the same wallet master private key and then the counter party can check the balance on those addresses to verify control over those funds without the controlling address having to conduct a transaction on the blockchain to prove it thus avoiding time for transaction to take place on the blockchain and avoiding the cost of the transaction.

1. A cryptocurrency system comprising:
a communication,
a wallet with a paycode and associated private key; paycode associated to enhanced identity,
where the wallet can send a zero knowledge proof on a communication channel to prove ownership of the private key and thus proof of the enhanced identity information.

2. A cryptocurrency system comprising:
a communication,
a wallet with a blockchain address and associated private key;
where the wallet can send a zero knowledge proof on a communication channel to prove ownership of the source blockchain address and thus provide proof of funds.

3. A cryptocurrency system comprising:
a communication,
a wallet with a private key;
where the wallet can send a zero knowledge proof on the communication channel to prove control of the private key.
